(19) United States
(12) Patent Application Publication
(10) Pub. No.: US 2016/0012115 A1
(43) Pub. Date: Jan. 14, 2016

(54) COMBINATIONAL DATA MINING

(71) Applicant: Celal Korkut VATA, (US)

(72) Inventor: Celal Korkut VATA, Ankara (TR)

(21) Appl. No.: 14/770,545

(22) PCT Filed: Oct. 14, 2013
(86) PCT No.: PCT/TR2013/000321

§ 371 Date: Aug. 26, 2015

(30) Foreign Application Priority Data
Feb. 28, 2013 (TR) 2013/02437

(51) Int. Cl. G06F 17/30

(52) U.S. Cl. CPC G06F 17/30572; G06F 17/30539; G06F 17/3053

(57) ABSTRACT

A combinatorial data mining system including a database selection unit allowing the user to choose at least one database among others; a unit of term entrance under the user choice unit allowing the user to enter terms of interest in to different list; a unit of occurrence frequency determination retrieving the occurrence frequencies of the terms of interest separately and co-occurrence frequencies of the terms of different lists in a combinatorial fashion on the database; a unit of data normalization calculating the ratio of term co-occurrence statistics to the separately occurrence statistics using various formula; a data integration unit integrating the normalized numeric results on a matrix and; a data display unit displaying the numerical results graphically in a color code to the user.

### TECHNICAL FIELD

The invention of interest is about a data mining system and a data mining method allowing the user to search on a database of interest with the potential of displaying the most relevant and meaningful results of the search terms to the end-user.

### PRIOR ART

A classical data mining approach consists of the steps of data cleaning, data integration and data display. International patent applications WO 2001/037072 and WO 2002/005209 are exemplar prior art referring to the steps of data cleaning and data integration steps of data mining.

There are efficient methods of data integration and data display. However, the step of background elimination (data cleaning) is usually problematic. The problems can be summarized as the following; same terms in different languages referring to the same concepts are represented by different numerical occurrence statistics across the databases. Therefore, the language barrier can not be overcomes. For example, particular investments of a Turkish drug company with a Turkish name can not be effectively searched against the investments of an American drug company with an English name. The second problem is the existence of different terms only as statistical figures with differences of orders of magnitude on huge databases. These statistical figures are mainly raw data and not processed information. For example, a search about the city of Istanbul can not be directly compared with a search on the city of Mu [symbol] as the city of Istanbul is at least two orders of magnitude more frequently represented than the city of Mu [symbol] on any public database. The third problem is that the classical data mining systems do not allow the user to search for specific information in a combinatorial fashion.

Although, the steps of data integration and data display of today are quite efficient the inefficiency of the background elimination is the biggest problem of the field. The invention of interest is mainly a system of data normalization before data integration and data display.

Therefore there is a great need for an advancement in the technical field to solve the problems mentioned above.

For example, when a user specifically searches for the binary term “data mining” the presence of terms “data” and “mining” separately on the database is the background. The invention of interest efficiently eliminates this problem.

### SHORT DESCRIPTION OF THE INVENTION

The invention of interest is aiming to eliminate the problems mentioned above and to potentiate the current data mining technology of today.

The particular work of interest is aiming to eliminate the problem of background information of data mining and to allow the user to retrieve meaningful results regarding the topic of interest.

Another aim of the invention is to allow the user to enter lists of keywords in double or triple combinations.

Another aim of the invention is to allow the user to select among different databases for a combinatorial search of interest.

Another aim of the invention is to display the results of the combinatorial search in a graphical format to the end-user.

Another aim of the invention is to allow the used to compare different search results on different databases with each other to delineate database specific responses.

Another aim of the invention is to allow the user to use terms of different languages on the same platform in a combinatorial fashion.

As mentioned above and further described below the invention of interest is about a combinatorial data mining system with the following specifications;
A unit for at least one database selection and a unit of keyword lists allowing the user to enter keywords of interest in a combinatorial fashion in different lists,
A unit of co-occurrence frequency retrieval wherein the unit extracts the co-occurrence and separately occurrence statistics of the terms of interest in a combinatorial fashion from the databases,
A unit of normalization wherein the ratio of co-occurrence statistics of the terms to the separately occurrence statistics are calculated using various formula,
A unit of data integration where the normalized data is integrated on a matrix,
A unit of data display where the data is displayed to the end-user in a graphical format,

The combinatorial data mining system functions on the following bases:
At least one database is chosen by the user,
The terms of interest are entered by the user in at least two lists with respect to the order of interest,
Determination of co-occurrence as well as separately occurrence frequencies for the terms of different lists in a combinatorial fashion,
Data normalization via ratio calculation of the co-occurrence statistics to the separately occurrence statistics using different ratio formula,
Background elimination according to the normalization step,
Graphical display of the results to the end-user,

The invention of interest should be considered along with the items and drawings as below to shed light on the relevant advantages.

### BRIEF DESCRIPTIONS OF THE DRAWINGS

FIG. 1 is a schematically display of the combinatorial data mining.

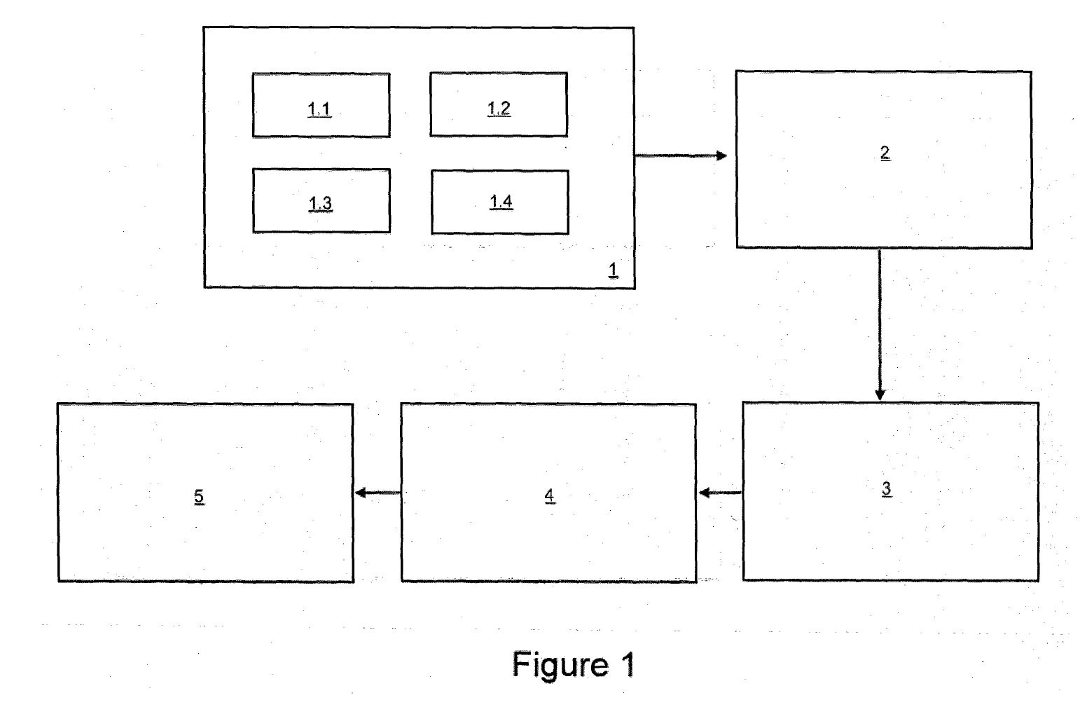

### REFERENCE NUMBERS

1 User Choice Unit
1.1 Unit of Database Selection
1.2 Unit of Criteria Determination
1.3 Unit of Database Selection

2 Unit of Term Frequency Determination

3 Unit of Data Normalization

4 Unit of Data Integration

5 Unit of Graphical Data display

With the option to chose a sub-database under the main database the user can specifically direct his/her search to the database of interest. Furthermore, using the criteria determination unit (1.2) the user can determine whether the terms of interest should be next to each other strictly or else the terms should only be on the same document.

The invention of interest allows the user to search for symptoms and diseases and to read and interpret the results in the following fashion:
The selection of the main database,
Entrance of the disease and symptom terms into list 1 and list 2 as below using the term entrance unit (1.3),

| List 1—Name of the Disease | List 2—Symptom |
|---|---|
| Alzheimer's Disease | Loss of Sleep |
| Delusional Disorder | Open Eyelids |
| Bipolar Manic Depressive Disorder | Agitation |
| | Shaky Hands |

Determination of the occurrence frequencies of terms in the list 1 and list 2 separately on the database,
Determination of the co-occurrence frequencies of terms in the list 1 and terms in list 2 in a combinatorial fashion,
Ratio normalization of the term frequencies of list 1 and list 2 in a combinatorial fashion,
Background elimination with respect to results of the normalization,
Integration of the cleaned data on a matrix and displaying to the end-user using the color code as below,

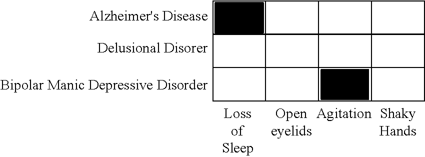 [SMILES: C1C2C3CC4C5C6CC7C8CC9C%10C1C21C34C52C76C89C%1012]

The matrix displays the relevance of diseases and symptoms using a color code. The relative color intensity reveals the relative correlation of the symptoms to the diseases allowing the user to interpret the results. As seen on the matrix the square of manic depression and agitation is marked with a higher color intensity than that of the square of Alzheimer's disease and agitation. Similarly, the square referring to loss of sleep symptom and Alzheimer's disease is with a higher color intensity than that of bipolar depressive disorder and loss of sleep. Based on these results the user can confidently conclude that loss of sleep is a major symptom of Alzheimer's disease and agitation is a major symptom of bipolar disorder.

The color intensities are a direct function of the numeric results of the normalization procedure.

The invention of interest allows the user to enter terms of different languages into the same list. For example, “Glaxo Smith Klein” the English term, “Sandoz” the German term, “Sanofi” the French term, “Daiichi Sankyo” the Japanese term and the “Abdi Ibrahim” the Turkish term can be entered in to the same list, list one. The terms of chollesterol lowering drugs

“Atorvastatin”, “Cericastatin”, “Fluvastatin” and “Lovastatin” can be entered into the other list, list 2. The results will show the user which company has invested into which drug extensively. The ratio calculation based background elimination allows the user to exclude all the language specific backgrounds for terms internationally. Therefore, the user is able to extract meaning regarding terms in different languages based on the numeric value of the term frequencies of different languages.

Similarly, the Turkish Term of “veri madencili\check{g}i”, the French Term of “l'exploration de donn'ees”, the English term of “data mining” and the Japanese term of [symbol] can be entered into the same list. If the English term “data mining” reveals a higher numeric value than the Turkish term “Veri madencili\check{g}i” the user can confidently conclude that the concept of data mining is more common in English speaking countries. Therefore, the system has a capacity to dissect the culture specific details in different languages.

1. A combinatorial data mining system characterized in comprising;
a unit of database selection allowing the user to choose a database of interest among others and a unit of term entrance allowing the user to enter terms into different lists on the user selection unit;
a unit of term frequency determination retrieving the database term frequencies separately as well as co-occurrence frequencies of different lists combinatorially;
a unit of data normalization, where the unit calculates the ratio of the cooccurrence statistics to the occurrence statistics of the separation;
a unit of data integration, wherein the system integrates the normalized data on a matrix; and,
a unit of graphical data display, wherein the system displays integrated data graphically to the user.

2. The combinatorial data mining system according to claim 1, wherein the unit allows the user to choose the function of normalization.

3. The combinatorial data mining system according to claim 1, wherein the unit of criteria determination of the user option unit allows the user to determine on the option of term co-occurrence next to each other or on the option of term cooccurrence on the same document.

4. A combinatorial data mining method with the following specifications:
the user chooses at least database among others;
the user enters terms of interest in at least two lists in to the system with respect to the order of interest;
the step of the determination of the co-occurrence statistics of one term of interest with another term of interest on the other list, for each term combination on a row;
the step of normalization, wherein the statistics of term co-occurrences are ratio normalized to the separately occurrence statistics;
the step of background elimination with respect to normalization; and,
the step of data display in a graphical format.

5. The combinatorial data mining method according to claim 4, wherein the criteria determination unit allows the user to choose between the options of term occurrence next to each other and the option of term occurrence separately on the same document.

6. The combinatorial data mining method according to claim 4, wherein the speed of data retrieval is determined by the user via criteria determination unit.

7. The combinatorial data mining method according to claim 4, wherein the normalization results of numeric values are indicated in quantitative color intensities on a matrix.

8. The combinatorial data mining method according to claim 4, wherein two numeric values of term occurrences and a single value of term co-occurrence are used in the three value normalization-ratio formula.

9. The combinatorial data mining method according to claim 7, wherein three different numerical values are used in different weighted ratio formula.
